(19) United States
(12) Patent Application Publication
(10) Pub. No.: US 2020/0208997 A1
(43) Pub. Date: Jul. 2, 2020

(54) NAVIGATION SYSTEM WITH AN ORDER OPTIMIZATION MECHANISM AND METHOD OF OPERATION THEREOF

(71) Applicant: TeleNav, Inc., Santa Clara, CA (US)

(72) Inventors: Kok Wei Koh, Mountain View, CA (US); Sylvain Castet, Mountain View, CA (US); Maher Lutfi Jilani, Cupertino, CA (US); Eric Wood, Menlo Park, CA (US)

(21) Appl. No.: 16/725,777

(22) Filed: Dec. 23, 2019

Related U.S. Application Data
(60) Provisional application No. 62/787,673, filed on Jan. 2, 2019.

(51) Int. Cl. G01C 21/34; G01C 21/36; G06Q 30/06; G06Q 10/08

(52) U.S. Cl. CPC G01C 21/343; G06Q 10/0836; G06Q 30/0635; G01C 21/3691

(57) ABSTRACT

A method of operation of a navigation system including generating an estimated arrival time for a navigation route including a destination; calculating a preparation time for an order; determining an ordering time to place the order to the destination such that the estimated arrival time at the destination is approximately at an end of the preparation time; communicating the order at the ordering time; and generating a guidance for the navigation route to arrive at the destination at approximately at an end of the preparation time.

### CROSS REFERENCE TO RELATED APPLICATION(S)

This application claims the benefit of U.S. Provisional Patent Application Ser. No. 62/787,673 filed Jan. 2, 2019, and the subject matter thereof is incorporated herein by reference thereto.

### TECHNICAL FIELD

An embodiment of the present invention relates generally to a navigation system and more particularly to a navigation system with an order optimization mechanism.

### BACKGROUND

Modern consumer and industrial electronics, especially devices such as cellular phones, smart phones, tablet computers, vehicle integrated computing and communication systems, portable digital assistants, and combination devices, are providing increasing levels of functionality to support modern life including communication services. Research and development in the existing technologies can take a myriad of different directions.

Ordering items such as food or beverages before going to pick the items up is a common task for many people. However, often times, the item is prepared much earlier or later than the time it is to be picked up. This means that items such as food or beverages get cold or stale, and are not as fresh as when the item is finished being prepared. Thus, a need still remains for a navigation system to optimize an ordering process such that items are delivered or picked up as close to the time they are finished being prepared to ensure they are given to customers at their freshest instance.

Solutions to these problems have been long sought but prior developments have not taught or suggested any solutions and, thus, solutions to these problems have long eluded those skilled in the art.

### SUMMARY

An embodiment of the present invention provides a method of operation of a navigation system including generating an estimated arrival time for a navigation route including a destination; calculating a preparation time for an order; determining an ordering time to place the order to the destination such that the estimated arrival time at the destination is approximately at an end of the preparation time; communicating the order at the ordering time; and generating a guidance for the navigation route to arrive at the destination at approximately at an end of the preparation time.

An embodiment of the present invention provides a navigation system including: a control unit configured to: a control unit configured to: generate an estimated arrival time for a navigation route including a destination; calculate a preparation time for an order; determine an ordering time to place the order to the destination such that the estimated arrival time at the destination is approximately at an end of the preparation time; generate a guidance for the navigation route to arrive at the destination at approximately at an end of the preparation time; and a communication unit, coupled to the control unit, configured to communicate the order at the ordering time.

An embodiment of the present invention provides a non-transitory computer readable medium including instructions for a navigation system comprising: including generating an estimated arrival time for a navigation route including a destination; calculating a preparation time for an order; determining an ordering time to place the order to the destination such that the estimated arrival time at the destination is approximately at an end of the preparation time; communicating the order at the ordering time; and generating a guidance for the navigation route to arrive at the destination at approximately at an end of the preparation time.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a navigation system with an order optimization mechanism in an embodiment of the present invention.

FIG. 2 is an example of a block diagram of the navigation system.

FIG. 3 is an example of a display interface of the navigation system.

FIG. 4 is a further example of the display interface of the navigation system.

FIG. 5 is an example of a sequence flow of the navigation system with the order optimization mechanism.

FIG. 6 is a first example of a sequence flow of the navigation system with the order optimization mechanism.

FIG. 7 is a second example a sequence flow of the navigation system with the order optimization mechanism.

FIG. 8 is a further example of a sequence flow of a of the navigation system.

FIG. 9 is a third example of the sequence flow of the navigation system with the order optimization mechanism.

FIG. 10 is a fourth example of the sequence flow of the navigation system with the order optimization mechanism.

FIG. 11 is a control flow of the navigation system.

FIG. 12 is flow chart of a method of operation of the navigation system in a further embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “vehicle” referred to herein can include cars, self-driving cars, trains, buses, bicycles, boats, motorcycles, airplanes, helicopters, or any other mode of transport, or a combination thereof in an embodiment of the present invention in accordance with the context in which the term is used.

The term “module” or “unit” referred to herein can include software, hardware, or a combination thereof in an embodiment of the present invention in accordance with the context in which the term is used. For example, the software can be machine code, firmware, embedded code, and application software. Also for example, the hardware can be circuitry, processor, a special purpose computer, integrated circuit, integrated circuit cores, a pressure sensor, an inertial sensor, a microelectromechanical system (MEMS), passive devices, or a combination thereof. Further, if a module is written in the system claims section below, the modules are deemed to include hardware circuitry for the purposes and the scope of system claims.

The modules in the following description of the embodiments can be coupled to one another as described or as shown. The coupling can be direct or indirect without or with, respectively, intervening items between coupled items. The coupling can be by physical contact or by communication between items.

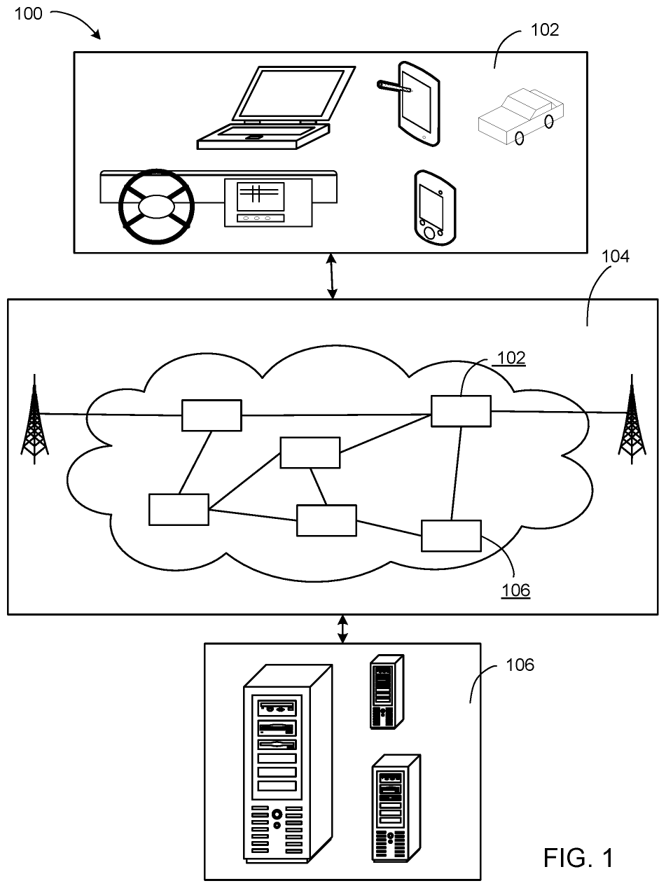

Referring now to FIG. 1, therein is shown a navigation system 100 with an order optimization mechanism in an embodiment of the present invention. The navigation system 100 includes a first device 102, such as a client or a server, connected to a second device 106, such as a client or server. The first device 102 can communicate with the second device 106 along a communication path 104, such as a wireless or wired network.

For example, the first device 102 can be of any of a variety of devices, such as a smart phone, cellular phone, personal digital assistant, tablet computer, a notebook computer, laptop computer, desktop computer, or a vehicle integrated communication system. The first device 102 can couple, either directly or indirectly, to the communication path 104 to communicate with the second device 106 or can be a stand-alone device. The first device 102 can be incorporated in a vehicle. In a further example, the first device 102 can be the vehicle.

The second device 106 can be any of a variety of centralized or decentralized computing devices. For example, the second device 106 can be a laptop computer, a desktop computer, grid-computing resources, a virtualized computer resource, cloud computing resources, routers, switches, peer-to-peer distributed computing devices, a server, or a combination thereof. The second device 106 can be centralized in a single room, distributed across different rooms, distributed across different geographical locations, embedded within a telecommunications network. The second device 106 can couple with the communication path 104 to communicate with the first device 102. The second device 106 can be incorporated in a vehicle. In a further example, the second device 106 can be the vehicle.

For illustrative purposes, the navigation system 100 is shown with the first device 102 as a client device, although it is understood that the navigation system 100 can have the first device 102 as a different type of device. For example, the first device 102 can be a server. Also for illustrative purposes, the navigation system 100 is shown with the second device 106 as a server, although it is understood that the navigation system 100 can have the second device 106 as a different type of device. For example, the second device 106 can be a client device.

For brevity of description in the embodiments discussed below, the first device 102 will be described as a client device and the second device 106 will be described as a server device. The embodiments of the present invention, however, are not limited to this selection for the type of devices. The selection is an example of an embodiment of the present invention.

Also for illustrative purposes, the navigation system 100 is shown with the second device 106 and the first device 102 as end points of the communication path 104, although it is understood that the navigation system 100 can have a different partition between the first device 102, the second device 106, and the communication path 104. For example, the first device 102, the second device 106, or a combination thereof can also function as part of the communication path 104.

The communication path 104 can span and represent a variety of networks and network topologies. For example, the communication path 104 can include wireless communication, wired communication, optical communication, ultrasonic communication, or the combination thereof. For example, satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Cable, Ethernet, digital subscriber line (DSL), fiber optic lines, fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

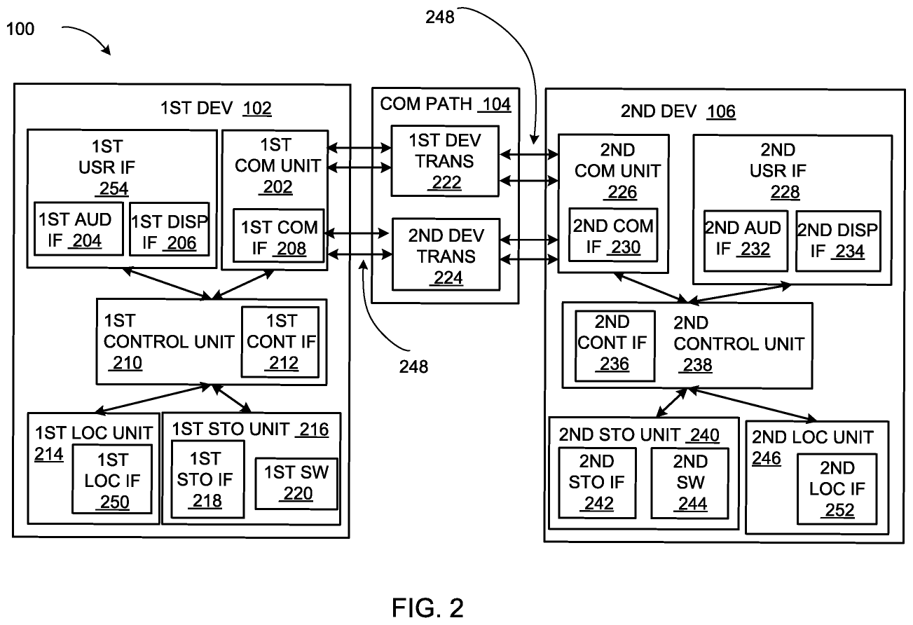

Referring now to FIG. 2, therein is shown an exemplary block diagram of the components of the navigation system 100. The first device 102 can send information in a first device transmission 222 over the communication path 104 to the second device 106. The second device 106 can send information in a second device transmission 224 over the communication path 104 to the first device 102. The first device transmission 222 and the second device transmission 224 can be sent over one or more communication channels 248. Each of the communication channels 248 refers either to a physical transmission medium, such as a wired for a wired communication, a logical connection over a multiplexed medium, a wireless communication, such as a radio channel, or a combination thereof.

For illustrative purposes, the navigation system 100 is shown with the first device 102 as a client device, although it is understood that the navigation system 100 can have the first device 102 as a different type of device. For example, the first device 102 can be a server.

Also for illustrative purposes, the navigation system 100 is shown with the second device 106 as a server, although it is understood that the navigation system 100 can have the second device 106 as a different type of device. For example, the second device 106 can be a client device.

For brevity of description in embodiments of the present invention, the first device 102 will be described as a client device and the second device 106 will be described as a server device. The embodiments of the present invention are not limited to this selection for the type of devices. The selection is an example of an embodiment of the present invention.

The first device 102 can include a first control unit 210, a first storage unit 216, a first communication unit 202, a first user interface 254, and a first location unit 214. The first control unit 210 can include a first control interface 212. The first control unit 210 can execute a first software 220 to provide the intelligence of the navigation system 100. The first control unit 210 can be implemented in a number of different ways. For example, the first control unit 210 can be a processor, an application specific integrated circuit (ASIC), an embedded processor, a microprocessor, a hardware control logic, a hardware finite state machine (FSM), a digital signal processor (DSP), or a combination thereof.

The first control interface 212 can be used for communication between the first control unit 210 and other functional units in the first device 102. The first control interface 212 can also be used for communication that is external to the first device 102. The first control interface 212 can receive information from the other functional units or from external sources, or can transmit information to the other functional units or to external destinations. The external sources and the external destinations refer to sources and destinations external to the first device 102.

The first control interface 212 can be implemented in different ways and can include different implementations depending on which functional units or external units are being interfaced with the first control interface 212. For example, the first control interface 212 can be implemented with a pressure sensor, an inertial sensor, a microelectromechanical system (MEMS), optical circuitry, waveguides, wireless circuitry, wireline circuitry, application programming interface, or a combination thereof.

The first storage unit 216 can store the first software 220. For illustrative purposes, the first storage unit 216 is shown as a single element, although it is understood that the first storage unit 216 can be a distribution of storage elements. Also for illustrative purposes, the navigation system 100 is shown with the first storage unit 216 as a single hierarchy storage system, although it is understood that the navigation system 100 can have the first storage unit 216 in a different configuration. For example, the first storage unit 216 can be formed with different storage technologies forming a memory hierarchal system including different levels of caching, main memory, rotating media, or off-line storage.

The first storage unit 216 can be a volatile memory, a nonvolatile memory, an internal memory, an external memory, or a combination thereof. For example, the first storage unit 216 can be a nonvolatile storage such as non-volatile random access memory (NVRAM), Flash memory, disk storage, or a volatile storage such as static random access memory (SRAM).

The first storage unit 216 can include a first storage interface 218. The first storage interface 218 can be used for communication between the first storage unit 216 and other functional units in the first device 102. The first storage interface 218 can also be used for communication that is external to the first device 102. The first storage interface 218 can receive information from the other functional units or from external sources, or can transmit information to the other functional units or to external destinations. The external sources and the external destinations refer to sources and destinations external to the first device 102.

The first storage interface 218 can include different implementations depending on which functional units or external units are being interfaced with the first storage unit 216. The first storage interface 218 can be implemented with technologies and techniques similar to the implementation of the first control interface 212.

The first communication unit 202 can enable external communication to and from the first device 102. For example, the first communication unit 202 can permit the first device 102 to communicate with the second device 106, an attachment, such as a peripheral device or a computer desktop, and the communication path 104.

The first communication unit 202 can also function as a communication hub allowing the first device 102 to function as part of the communication path 104 and not be limited to be an end point or terminal unit to the communication path 104. The first communication unit 202 can include active and passive components, such as microelectronics or an antenna, for interaction with the communication path 104.

The first communication unit 202 can include a first communication interface 208. The first communication interface 208 can be used for communication between the first communication unit 202 and other functional units in the first device 102. The first communication interface 208 can receive information from the other functional units or from external sources, or can transmit information to the other functional units or to external destinations. The external sources and the external destinations refer to sources and destinations external to the first device 102.

The first communication interface 208 can include different implementations depending on which functional units are being interfaced with the first communication unit 202. The first communication interface 208 can be implemented with technologies and techniques similar to the implementation of the first control interface 212.

The first communication unit 202 can couple with the communication path 104 to send information to the second device 106 in the first device transmission 222. The second device 106 can receive information in a second communication unit 226 from the first device transmission 222 of the communication path 104.

The first control unit 210 can operate the first user interface 254 to present information generated by the navigation system 100. The first user interface 254, in one embodiment, allows a user of the navigation system 100 to interface with the first device 102. The first user interface 254 can include an input device and an output device. Examples of the input device of the first user interface 254 can include a keypad, a touchpad, soft-keys, a keyboard, a microphone, sensors for receiving remote signals, or any combination thereof to provide data and communication inputs. Examples of the output device can include a first display interface 206 and a first audio interface 204.

The first control unit 210 can operate the first user interface 254 to present information generated by the navigation system 100. The first control unit 210 can also execute the first software 220 for the other functions of the navigation system 100. The first control unit 210 can further execute the first software 220 for interaction with the communication path 104 via the first communication unit 202.

The first display interface 206 can be any graphical user interface such as a display, a projector, a video screen, or any combination thereof. The first audio interface 204 can include sensors, speakers, microphones, headphones, subwoofers, surround sound components, transducers, or any combination thereof. The first display interface 206 and the first audio interface 204 allow a user of the navigation system 100 to interact with the navigation system 100.

The first location unit 214 can generate location information, current heading, and current speed of the first device 102, as examples. The first location unit 214 can be implemented in many ways. For example, the first location unit 214 can function as at least a part of a global positioning system (GPS) and can include components, such as a GPS receiver, an inertial navigation system, a cellular-tower location system, a pressure location system, or any combination thereof.

The first location unit 214 can include a first location interface 250. The first location interface 250 can be used for communication between the first location unit 214 and other functional units in the first device 102. The first location interface 250 can also be used for communication that is external to the first device 102. The first location interface 250 can be implemented with technologies and techniques similar to the implementation of the first control interface 212.

The second device 106 can be optimized for implementing an embodiment of the present invention in a multiple device embodiment with the first device 102. The second device 106 can provide additional or higher performance processing power compared to the first device 102. The second device 106 can include a second control unit 238, a second storage unit 240, the second communication unit 226, a second user interface 228, and a second location unit 246.

The second control unit 238 can include a second control interface 236. The second control unit 238 can execute a second software 244 to provide the intelligence of the navigation system 100. The second software 244 can also operate independently or in conjunction with the first software 220. The second control unit 238 can provide additional performance compared to the first control unit 210.

The second control unit 238 can be implemented in a number of different ways. For example, the second control unit 238 can be a processor, an application specific integrated circuit (ASIC), an embedded processor, a microprocessor, a hardware control logic, a hardware finite state machine (FSM), a digital signal processor (DSP), or a combination thereof.

The second control interface 236 can be used for communication between the second control unit 238 and other functional units in the second device 106. The second control interface 236 can also be used for communication that is external to the second device 106. The second control interface 236 can receive information from the other functional units or from external sources, or can transmit information to the other functional units or to external destinations. The external sources and the external destinations refer to sources and destinations external to the second device 106.

The second control interface 236 can be implemented in different ways and can include different implementations depending on which functional units or external units are being interfaced with the second control interface 236. For example, the second control interface 236 can be implemented with a pressure sensor, an inertial sensor, a microelectromechanical system (MEMS), optical circuitry, waveguides, wireless circuitry, wireline circuitry, application programming interface, or a combination thereof.

The second storage unit 240 can store the second software 244. The second storage unit 240 can be sized to provide the additional storage capacity to supplement the first storage unit 216. For illustrative purposes, the second storage unit 240 is shown as a single element, although it is understood that the second storage unit 240 can be a distribution of storage elements. Also for illustrative purposes, the navigation system 100 is shown with the second storage unit 240 as a single hierarchy storage system, although it is understood that the navigation system 100 can have the second storage unit 240 in a different configuration. For example, the second storage unit 240 can be formed with different storage technologies forming a memory hierarchal system including different levels of caching, main memory, rotating media, or off-line storage.

The second storage unit 240 can be a volatile memory, a nonvolatile memory, an internal memory, an external memory, or a combination thereof. For example, the second storage unit 240 can be a nonvolatile storage such as non-volatile random access memory (NVRAM), Flash memory, disk storage, or a volatile storage such as static random access memory (SRAM).

The second storage unit 240 can include a second storage interface 242. The second storage interface 242 can be used for communication between the second storage unit 240 and other functional units in the second device 106. The second storage interface 242 can also be used for communication that is external to the second device 106. The second storage interface 242 can receive information from the other functional units or from external sources, or can transmit information to the other functional units or to external destinations. The external sources and the external destinations refer to sources and destinations external to the second device 106.

The second storage interface 242 can include different implementations depending on which functional units or external units are being interfaced with the second storage unit 240. The second storage interface 242 can be implemented with technologies and techniques similar to the implementation of the second control interface 236.

The second communication unit 226 can enable external communication to and from the second device 106. For example, the second communication unit 226 can permit the second device 106 to communicate with the first device 102 of FIG. 1, an attachment, such as a peripheral device or a computer desktop, and the communication path 104.

The second communication unit 226 can also function as a communication hub allowing the second device 106 to function as part of the communication path 104 and not be limited to be an end point or terminal unit to the communication path 104. The second communication unit 226 can include active and passive components, such as microelectronics or an antenna, for interaction with the communication path 104.

The second communication unit 226 can include a second communication interface 230. The second communication interface 230 can be used for communication between the second communication unit 226 and other functional units in the second device 106. The second communication interface 230 can receive information from the other functional units or from external sources, or can transmit information to the other functional units or to external destinations. The external sources and the external destinations refer to sources and destinations external to the second device 106.

The second communication interface 230 can include different implementations depending on which functional units are being interfaced with the second communication unit 226. The second communication interface 230 can be implemented with technologies and techniques similar to the implementation of the second control interface 236.

The second communication unit 226 can couple with the communication path 104 to send information to the first device 102 in the second device transmission 224. The first device 102 can receive information in the first communication unit 202 from the second device transmission 224 of the communication path 104.

The second control unit 238 can operate the second user interface 228 to present information generated by the navigation system 100. The second user interface 228, in one embodiment, allows a user of the navigation system 100 to interface with the second device 106. The second user interface 228 can include an input device and an output device. Examples of the input device of the second user interface 228 can include a keypad, a touchpad, soft-keys, a keyboard, a microphone, sensors for receiving remote signals, or any combination thereof to provide data and communication inputs. Examples of the output device can include a second display interface 234 and a second audio interface 232.

The second control unit 238 can operate the second user interface 228 to present information generated by the navigation system 100. The second control unit 238 can also execute the second software 244 for the other functions of the navigation system 100. The second control unit 238 can further execute the second software 244 for interaction with the communication path 104 via the second communication unit 226.

The second display interface 234 can be any graphical user interface such as a display, a projector, a video screen, or any combination thereof. The second audio interface 232 can include sensors, speakers, microphones, headphones, subwoofers, surround sound components, transducers, or any combination thereof. The second display interface 234 and the second audio interface 232 allow a user of the navigation system 100 to interact with the navigation system 100.

The second location unit 246 can generate location information, current heading, and current speed of the second device 106, as examples. The second location unit 246 can be implemented in many ways. For example, the second location unit 246 can function as at least a part of a global positioning system (GPS) and can include components, such as a GPS receiver, an inertial navigation system, a cellular-tower location system, a pressure location system, or any combination thereof.

The second location unit 246 can include a second location interface 252. The second location interface 252 can be used for communication between the second location unit 246 and other functional units in the second device 106. The second location interface 252 can also be used for communication that is external to the second device 106. The second location interface 252 can be implemented with technologies and techniques similar to the implementation of the second control interface 236.

Functionality of the navigation system 100 can be provided by the first control unit 210, the second control unit 238, or a combination thereof. For illustrative purposes, the second device 106 is shown with the partition having the second user interface 228, the second storage unit 240, the second control unit 238, the second location unit 246, and the second communication unit 226, although it is understood that the second device 106 can have a different partition. For example, the second software 244 can be partitioned differently such that some or all of its function can be in the second control unit 238 and the second communication unit 226. Also, the second device 106 can include other functional units not shown in FIG. 2 for clarity.

The first device 102 can have a similar or different partition as the second device 106. The functional units in the first device 102 can work individually and independently of the other functional units. The first device 102 can work individually and independently from the second device 106 and the communication path 104. The functional units in the second device 106 can work individually and independently of the other functional units. The second device 106 can work individually and independently from the first device 102 and the communication path 104.

For illustrative purposes, the navigation system 100 is described by operation of the first device 102 and the second device 106. It is understood that the first device 102 and the second device 106 can operate any of the modules, units, and functions of the navigation system 100.

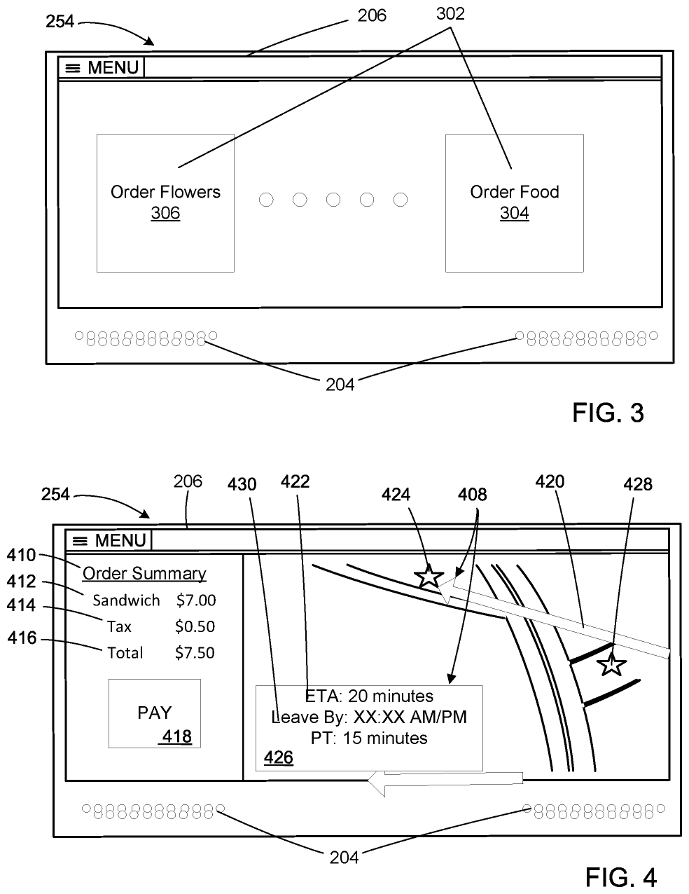

Referring now to FIG. 3, therein is shown an example of a display interface of the navigation system 100. As a specific example, FIG. 3 shows an embodiment of the first user interface 254 of the first device 102 of FIG. 1 or the second user interface 228 of FIG. 2 of the second device 106 of FIG. 1 prior to the user of the navigation system 100 ordering an item. For brevity of description, in this embodiment, reference to the first user interface 254 will be made, however, the descriptions with respect to the first user interface 254 can be similarly applicable to the second user interface 228.

In one embodiment, the first user interface 254 can include the first display interface 206. The first display interface 206 can enable a user of the navigation system 100 to place an order 302 for an item. An item refers to goods or services that can be picked up by a user of the navigation system 100 or delivered to a user of the navigation system 100. The item can be ordered from a third party vendor or merchant using an icon for the order 302 displayed or projected on the first display interface 206. The icon is a symbol or graphical area of representation displayed on the first display interface 206. As shown in FIG. 3, different types for the order 302 can be selected with different types or different instances of the icon.

In one embodiment, the order 302 can be engaged by touch to enable users of the navigation system 100 to order items. The order 302 or the icon for the order 302 can symbolize or represent a variety of the item that can be ordered. For example, in one embodiment, the order 302 can include the icon for a food order 304 for ordering food from a vendor or merchant. In another embodiment, the order 302 can include the icon for a flower order 306 for ordering flowers from a vendor or merchant. Food and flowers are disclosed as examples of items that can be ordered, and are not meant to be limiting. The icon for the order 302 can represent any number or type of the item for delivery to or pick up by a user of the navigation system 100, particularly for example, the item in which time of delivery or pick up is an important factor.

The importance factor to a user can refer to the desirability of the item to a user. For example, food typically has more appeal or more important to a user when it is fresh, and is more desirable to the user if it is delivered or picked up closer to the time in which it was finished being prepared. Similarly, flowers typically have more appeal or more important to a user if they are freshly cut and picked up or delivered closer to the time in which they have been freshly cut or prepared as, for example, a bouquet.

Continuing with the example, a user of the navigation system 100 can engage the icon for the order 302, in one embodiment, by touching the icon for the order 302 for the item to be ordered. For example, in one embodiment, if the user of the navigation system 100 wants to order food the user can touch the icon for the food order 304. Once touched, the icon for the food order 304 can invoke the navigation system 100 to communicate with a third party vendor or merchant so the user can place the order for food with that vendor or merchant or the navigation system 100 can order the item with the third party vendor or merchant. In one embodiment, the icon for the food order 304 can include sub-icons and lists presented to the user when it is engaged, to further enable the user to place the order 302. The sub-icons and lists can, for example, include the vendor or merchant's menus, list items that can be ordered by the user through the navigation system 100, or a combination thereof. The user can choose from the items in the sub-icons and lists to finalize the order 302. The navigation system 100 can optimize the order 302 such that the item is picked up or delivered at an optimal time. The overall process is referred to as the order optimization mechanism hereinafter. Details of the order optimization mechanism will be discussed in greater detail below.

In another embodiment, the first audio interface 204, the first display interface 206, or a combination thereof can enable the user of the navigation system 100 to place an order using an audio command. The audio command refers to instructions given to the navigation system 100 using a verbal input, such as voice, or other acoustic, mechanical, or electrical frequencies corresponding to audible sound waves. For example, the audio command can be received through one or more sensors, microphones, transducers, or a combination thereof using the first audio interface 204. The audio command can enable the navigation system 100 to communicate with a third party vendor or merchant to enable the user to place an order using a similar process to what was described above. In a further example, the audio command can invoke the navigation system to place the order with the third party vendor or merchant.

For example, in one embodiment, a user can place an order for food using the first audio interface 204 by prompting the navigation system 100 using voice commands. For example, the user can prompt the navigation system 100 by using key words or phrases or a barge-in phase, such as “hey system” or “system begin order”, to start the ordering process. The user can then place the order by further indicating which items the user wants to order. For example, in the case where the user wants to order food, for example a pizza, the user can further prompt the navigation system 100 by saying “order a large pepperoni pizza from” and further include the appropriate vendor or merchant at the end of the phrase, such as Domino's, Pizza Hut, or another vendor of the user's choice. Once spoken, the key words or phrases enable the navigation system 100 to communicate with the third party vendor or merchant to place the user's order. The user can order any number of items in a similar fashion.

Referring now to FIG. 4, therein is shown a further example of the display interface of the navigation system 100. As a specific example, FIG. 4 shows an embodiment of the first user interface 254 of the first device 102 of FIG. 1 or the second user interface 228 of FIG. 2 of the second device 106 of FIG. 1 for the navigation system 100 to place the order 302 of FIG. 3 an item. Again, with respect to FIG. 4, for brevity of description, in this embodiment, reference to the first user interface 254 will be made, however, the descriptions with respect to the first user interface 254 can be similarly applicable to the second user interface 228.

In one embodiment shown in FIG. 4, the navigation system 100 placed the order, the first display interface 206 can display or project an order summary 410. The order summary 410 is a brief statement or account of the user's order. The order summary 410 can include information regarding the user's order. For example, the order summary 410 can include an itemized list 412 of items ordered, tax information 414 for the items ordered, a total price 416 for the user's order, or a combination thereof. This example is not meant to be limiting and other information relevant to the order 302 can be included in the order summary 410, including for example, discounts applied.

In an embodiment, the first display interface 206 can also include a payment icon 418. The payment icon 418 is a symbol or graphical area of representation displayed on the first display interface 206 that allows the user of the navigation system 100 to make a payment to the vendor or merchant. Payment refers to the exchange of a form of currency as a condition of fulfilling the order. Payment can include, for example, any acceptable exchange of currency including money, credit, cryptocurrency, merchant loyalty points, credits, or any combination thereof.

In one embodiment, the payment icon 418 is engaged by touch or by the navigation system 100. The user of the navigation system 100 can touch the payment icon 418 to make a payment to the merchant or vendor. The payment icon 418 can enable the navigation system 100 to communicate directly with vendor or merchant to transfer a user's payment information, including credit card information, bank account information, or other information necessary to make a payment to the vendor or merchant. The user's payment information can be stored in the first storage unit 216 of FIG. 2 or the second storage unit 240 of FIG. 2 to expedite payment to the vendor or merchant.

In another embodiment, a payment can be made by a user through the audio command using the first audio interface 204. For example, the user can prompt the navigation system 100 to make a payment by using key words or phrases or barge-in phrases, such as “hey system make a payment” or “make payment”, to begin the payment process. Once spoken, the audio command can enable the navigation system 100 to communicate with the third party vendor or merchant to make the payment by transferring a user's payment information, including credit card information, bank account information, or other information necessary to make a payment to the vendor or merchant similar to what was described above.

In an embodiment, the first display interface 206 can also include navigation information 408. The navigation information 408 refers to information to facilitate the delivery or pick up of the items ordered. The navigation information 408 can include a variety of information. As examples, the navigation information 408 can include a navigation route 420, an estimated arrival time 422 to the merchant or vendor as a destination 424 of the navigation route 420, a guidance 426 for the navigation route 420, or a combination thereof.

The navigation route 420 provides the path for traversal starting location to the destination 424. The destination 424 is the end of the navigation route 420. The navigation route 420 can include a waypoint 428 in addition to the destination 424. The waypoint 428 is a stop along the navigation route 420 but does not necessarily represent the end of the navigation route 420. As an example, the waypoint 428 can represent an intermediate stop along the navigation route 420 before terminating a navigation session for the navigation route 420 where the destination 424 is intended to be the end or termination of the navigation session of the navigation route 420.

In the example and context of the order 302, the destination 424 can represent the pickup location for the order 302 or the geographic location of the merchant or vendor for the order 302. Continuing this example, the waypoint 428 can also represent the pickup location for the order 302 or the geographic location of the merchant or vendor for the order 302.

The estimated arrival time 422 represents a time to traverse the navigation route 420 to the destination 424, the waypoint 428, or a combination thereof. The navigation system 100, the first device 102, the second device 106, or a combination thereof can take various factors into account to determine or calculate or generate the estimated arrival time 422. For example, the estimated arrival time 422 can be computed taking into account traffic conditions, current or project for time of departure. Also for example, the estimated arrival time 422 can be computed taking into the account the modes of transportation or multi-modal transportation, such as car, walking, public transportation and associated schedules, or a combination thereof.

The guidance 426 for the navigation route 420 includes instructions to reach the destination 424, the waypoint 428, or a combination thereof. The guidance 426 can include instructions, such as step-by-step instructions. As examples, the guidance 426 can be presented via image, video, audio, augmented reality, overlays on maps, or a combination thereof.

Further, the navigation information 408 can also include other information related to or associated with the order 302. For example, the navigation information 408 can include a recommended departure time 430. The recommended departure time 430 represents a “leave by” time to inform the user who placed the order 302 or a person delivering the order 302 when the best time to leave to pick up the order 302. will be, the time the vendor or merchant needs to prepare the order, directions to the vendor or merchant, or a combination thereof. The list is not meant to be limiting and other relevant factors for the navigation information 408 can be included.

A portion of the navigation information 408 can utilize portions of the navigation system 100, such as through the use of the first location unit 214 of the first device 102, the second location unit 246 of the second device 106, or a combination thereof in conjunction with map information stored either on the first storage unit 216, the second storage unit 240, external databases, or a combination thereof. Further, the navigation information 408 can also be obtained, either partly or in whole through communication between the navigation system 100 and the merchant or vendor in conjunction, or separate from the first location unit 214, the second location unit 246, or a combination thereof. Communication can be done through the first communication unit 202 of the first device 102, the second communication unit 226 of the second device 106, or a combination thereof.

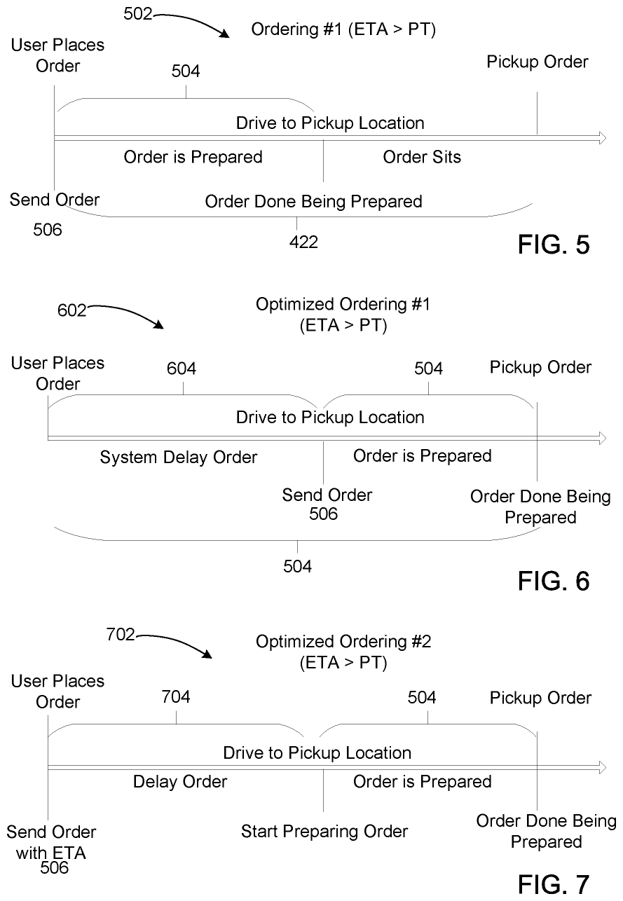

Referring now to FIG. 5, therein is shown is an example of a sequence flow 502 of a the navigation system 100 of FIG. 1 with the order optimization mechanism. FIG. 5 depicts an example in which the estimated arrival time 422 to the merchant or vendor is greater than a preparation time 504. The preparation time 504 is amount of time a merchant or a vendor needs to prepare the order 302.

For brevity and clarity, FIG. 5 as well as much of the description throughout this document describes the destination 424 as the location for the merchant or the vendor for the order 302. However, the description for FIG. 5 and much of the description throughout this document can also be described with the waypoint 428 of FIG. 4 as the location for the merchant or the vendor for the order 302.

Returning to the example depicted in FIG. 5, the non-optimized ordering process is shown when the user, the navigation system 100, the first device 102 of FIG. 1, the second device 106 of FIG. 1, or a combination thereof places the order 302. Continuing this example, an ordering time 506 for the order 302 is immediate or sent or communicated to the merchant or the vendor at the destination 424 without delay by the navigation system 100, the first device 102, the second device 106, or a combination thereof. The ordering time 506 is the time or timing of when the navigation system 100, the first device 102, the second device 106, or a combination thereof.

The navigation system 100, the first device 102, the second device 106, or a combination thereof can determine or generate the ordering time 506 based on various factors. For example, the ordering time 506 attempts to coincide the estimated arrival time 422 to an approximate end of the preparation time 504 for the order 302 at the destination 424. In other words, the order 302 is ready for pick up at the approximate completion of the preparation time 504 just as the guidance 426 of FIG. 4 allows the first device 102, as an example, to reach the destination 424.

Returning to the example sequence flow, the vendor or the merchant at the destination can then immediately starts to prepare the order 302 while the user of the navigation system 100 drives to the destination 424 utilizing the navigation route 420, the guidance 426, or a combination thereof to pick up the order 302. Because the estimated arrival time 422 to the destination 424 is greater than the preparation time 504 the vendor or the merchant needs, the order 302 is prepared prior to the arrival to the destination 424 and the order 302 will sit at the destination 424 until the user arrives. In this example, the order 302 will get cold, stale, or is otherwise not be in its optimal state when the user arrives.

Referring now to FIG. 6, therein is shown a first example of a sequence flow 602 of the navigation system 100 of FIG. 1 with the order optimization mechanism. In this example, FIG. 6 shows an embodiment of the sequence flow 602 where the navigation system 100, the first device 102 of FIG. 1, the second device 106 of FIG. 1, or a combination thereof delays the order 302 of FIG. 3 to align the estimated arrival time 422 to the merchant or the vendor at the destination 424. In other words, the navigation system 100, the first device 102, the second device 106, or a combination thereof determines the ordering time 506 to delay when to communicate the order 302 to the merchant or the vendor at the destination 424. Continuing with this example, the estimated arrival time 422 to the merchant or the vendor at the destination 424 for the order 302 is greater than the preparation time 504 by the merchant or the vendor at the destination 424.

In this example, the sequence flow 602 depicts the order 302 being initiated to the navigation system 100, the first device 102, the second device 106, or a combination thereof. Once the order 302 is initiated, the navigation system 100, the first device 102, the second device 106, or a combination thereof compares the estimated arrival time 422 to the merchant or the vendor at the destination 424 to the preparation time 504 needed by the vendor or the merchant at the destination 424.

The navigation system 100, the first device 102, the second device 106, or a combination thereof can determine the ordering time 506 or in other words, whether to a delay time 604 is needed for sending of the order 302 to the merchant or the vendor at the destination 424 and by how much time. The delay time 604 refers to a time lag of the communication of the order 302 by the navigation system 100 to the merchant or the vendor at the destination 424 and this will be described later. In one embodiment, the navigation system 100, the first device 102, the second device 106, or a combination thereof can determine the ordering time 506 such that the estimated arrival time 422 to the destination 424 equals the preparation time 504 or the end of the preparation time 504 for the order 302. For example, if the estimated arrival time 422 to the destination 424 is 20 minutes but the preparation time 504 for the order 302 is 10 minutes, the navigation system 100, the first device 102, the second device 106, or a combination thereof can set the ordering time 506 to delay sending or communicating the order 302 for 10 minutes, such that the order 302 will be prepared just in time for when the user comes to pick up the order, ensuring that the order will be picked up as close to the time as the order is finished being prepared as possible.

In one embodiment, the estimated arrival time 422 to the destination 424 can be computed or determined, for example, using location information provided by the first location unit 214 of FIG. 1, the second location unit 246 of FIG. 1, or a combination thereof. In one embodiment, the preparation time 504 for the order 302 can be determined using average times computed or provided for making the same or similar items for the order 302 in the past. As an example, the preparation time 504 can be available to the navigation system 100 and stored in the first storage unit 216 of FIG. 1, the second storage unit 240 of FIG. 1, an external database, or a combination thereof.

In another embodiment as an example, the navigation system 100, the first device 102, the second device 106, or a combination thereof can learn from additional instances of the preparation time 504 for the order 302 for an item through a feedback mechanism, such that the navigation system 100, the first device 102, the second device 106, or a combination thereof can build an ongoing repository of knowledge of various instances of the order 302 and the preparation time 504 by the vendors or the merchants need to fulfill the order 302. The accumulated knowledge can allow the navigation system 100 to become more precise and accurate over time. In another embodiment, the system can implement an intelligence engine, such as an artificial intelligence engine to facilitate this learning process. The artificial intelligence engine can be implemented in a variety of ways including, for example, through techniques including supervised, unsupervised, or reinforced learning.

Referring now to FIG. 7, therein is shown a second example a sequence flow 702 of the navigation system 100 of FIG. 1 with the order optimization mechanism. As an example, FIG. 7 shows an embodiment of the sequence flow 702, wherein the navigation system 100, the first device 102 of FIG. 1, the second device 106 of FIG. 1, or a combination thereof sends or communicates the order 302 immediately after the order 302 has been initiated such that the ordering time 506 without delay to the merchant or the vendor at the destination 424. The navigation system 100 can also communicate the estimated arrival time 422 to the destination 424.

Continuing with this example, the merchant or the vendor at the destination 424 can delay preparation of the order 302 by a vendor delay 704 to align the estimated arrival time 422 to the destination 424 and the preparation time 504. The vendor delay 704 is the when the vendor or the merchant at the destination 424 does not start the preparation of the order 302 for an amount of time. FIG. 7 also depicts the estimated arrival time 422 is greater than the preparation time 504 for the order 302.

In this example, the sequence flow 702 is shown with the order 302 being initiated to the navigation system 100. The navigation system 100, the first device 102, the second device 106, or a combination thereof can send or communicate the order 302 to the merchant or the vendor at the destination 424 as well as the estimated arrival time 422. The merchant or the vendor can determine the vendor delay 704, in other words, at what point to begin preparing the order 302 such that the end of the preparation time 504 for the order 302 is approximately the same time as the estimated arrival time 422 at the destination 424 for the pick up the order 302.

For example, in one embodiment, if the estimated arrival time 422 to the merchant or the vendor at the destination 424 is 20 minutes but the preparation time 504 for the order 302 is 10 minutes, the merchant or the vendor at the destination 424 can delay starting the preparation of the order 302 for the vendor delay 704 of 10 minutes, such that the order 302 can be prepared just in time for when the user comes to pick up the order, ensuring that the order 302 will be picked up as close to the time as the order is finished being prepared as possible. The estimated arrival time 422 to the merchant or the vendor at the destination 424 and the preparation time 504 can be computed or determined similarly as described in FIG. 6.

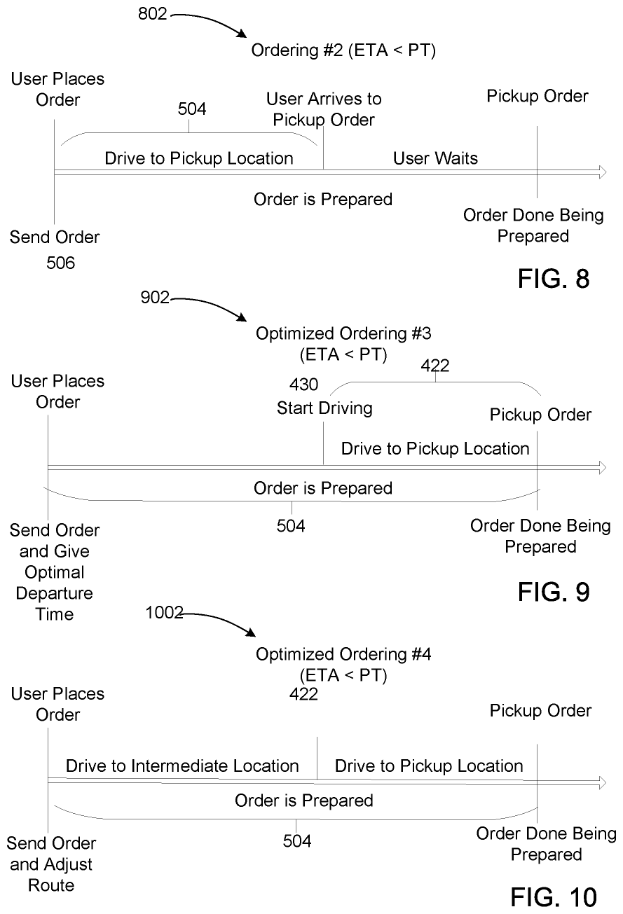

Referring now to FIG. 8, therein is shown further example of a sequence flow 802 of the navigation system 100 of FIG. 1. In this example, the sequence flow 802 depicts the estimated arrival time 422 to the merchant or the vendor at the destination 424 is less than the preparation time 504 for the order 302.

As an example, the sequence flow 802 depicts the order 302 as initiated and the order 302 is immediately sent or communicated, with the ordering time 506 set to zero or not factored in, to the merchant or the vendor at the destination 424. The vendor or the merchant at the destination 424 can immediately start to prepare the order 302 with the vendor delay 704 of FIG. 7 being zero or not factored in while, for example, the user traverses the navigation route 420 of FIG. 3 to the destination 424 to pick up the order 302. Because the estimated arrival time 422 to the merchant or the vendor at the destination 424 is less than the preparation time 504 for the order 302, the user arrives earlier than when the order 302 is finished being prepared and will have to wait for the order 302 wasting his or her time.

Referring now to FIG. 9, therein is shown a third example of a sequence flow 902 of the navigation system 100 of FIG. 1 with the order optimization mechanism. In this example, FIG. 9 shows an embodiment of the sequence flow 902 where the navigation system 100, the first device 102 of FIG. 1, the second device 106 of FIG. 1, or a combination thereof sends or communicates the order 302 to the merchant or the vendor at the destination 424 and determines the recommended departure time 430 or an optimal departure time to traverse the navigation route 420 of FIG. 3 to align the estimated arrival time 422 to the destination 424 and the preparation time 504. Further to this example, the estimated arrival time 422 to the destination 424 is less than the preparation time 504 for the order 302.

In this example, the sequence flow 902 depicts the order 302 being initiated. The navigation system 100, the first device 102, the second device 106, or a combination thereof sends or communicates the order 302 to the merchant or the vendor at the destination 424. The navigation system 100 can further determine the recommended departure time 430 to traverse the navigation route 420 to the destination 424 to pick up the order 302. The navigation system 100 can determine the recommended departure time 430 by obtaining information from the merchant or the vendor related to the preparation time 504 for the order 302.

For example, the navigation system 100 can communicate with the merchant or the vendor at the destination 424 through the first communication unit 202 of FIG. 2, the second communication unit 226 of FIG. 2, or a combination thereof, to receive or communicate the preparation time 504 for the order 302. The navigation system 100 can utilize the preparation time 504 to determine the recommended departure time 430 enabling a traversal of the navigation route 420 to arrive at the destination 424 at or approximately the same time the order 302 is done being prepared.

Continuing with this example, the navigation system 100 can determine the estimated arrival time 422 to the destination 424 in part by utilizing the first location unit 214 of FIG. 2, the second location unit 246 of FIG. 2, or a combination thereof. The merchant or the vendor at the destination 424 send to or communicate with the navigation system 100 the preparation time 504 for the order 302. The navigation system 100, the first device 102, the second device 106, or a combination there can utilize the preparation time 504 for the order 302 from the merchant or the vendor at the destination 424 to compare with the estimated arrival time 422 and determine the recommended departure time 430 to traverse the navigation route 420 to the destination 424 to pick up the order 302.

For example, if the preparation time 504 for the order 302 is 20 minutes and the estimated arrival time 422 to traverse the navigation route 420 is 10 minutes, the navigation system 100, the first device 102, the second device 106, or a combination thereof can generate the recommended departure time 430 to traverse the navigation route 420 is 10 minutes later so that time the user arrives approximately at the end of the preparation time 504 for the order 302. In this example, the user does not unnecessarily wait for the order 302 to be prepared.

Referring now to FIG. 10, therein is shown a fourth example of a sequence flow 1002 of the navigation system 100 of FIG. 1 with the order optimization mechanism. As an example, FIG. 10 shows an embodiment of the sequence flow 1002 where the navigation system 100, the first device 102 of FIG. 1, the second device 106 of FIG. 1, or a combination thereof sends, receives, or communicates the order 302 to the merchant or the vendor at the destination 424. Continuing with this example, the navigation system 100 can adjust the navigation route 420 of FIG. 3 to account for the difference in time between the estimated arrival time 422 and the preparation time 504 for the order 302. As a specific example, FIG. 10 also depicts the estimated arrival time 422 is less than the preparation time 504 for the order 302.

In this example, the sequence flow 1002 depicts the order 302 being initiated. The navigation system 100, the first device 102, the second device 106, or a combination thereof sends, receives, or communicates the order 302 to the merchant or the vendor at the destination 424. The merchant or the vendor can review the order 302 and send back to the navigation system 100 the preparation time 504 for the order 302. The navigation system 100 can compare the preparation time 504 for the order 302 and the estimated arrival time 422 to determine the navigation route 420 to the destination 424 such that the user can arrive at the destination 424 at the same time or approximately the same time that the order 302 is finished being prepared.

The navigation system 100 can generate the navigation route 420 in a number of different ways. In one embodiment, the navigation system 100 can generate the navigation route 420 that extends the estimated arrival time 422 rather than to minimize the estimated arrival time 422 to the destination 424. The user will arrive at or around the same time that the order 302 is finished being prepared and avoiding the user waiting at the destination 424 for the order 302 to be finished being prepared.

In another embodiment, the navigation system 100, the first device 102, the second device 106, or a combination thereof can generate the navigation route 420 with multiple stops or the waypoint 428 of FIG. 4 on the way to the pickup location as the destination 424. In these examples, the navigation system 100 can generate the waypoint 428 for other tasks or errands the user has to fulfill. For example, the waypoint 428 can represent a pick up location for other items ordered from other vendors or merchants that are ready to be picked up prior to the time the order 302 is finished being prepared. In this example, the navigation system 100 can optimize a user's schedule by allowing the user to perform multiple pickups on the same trip and at the same time allowing the user to pick up the order 302 at an optimal time.

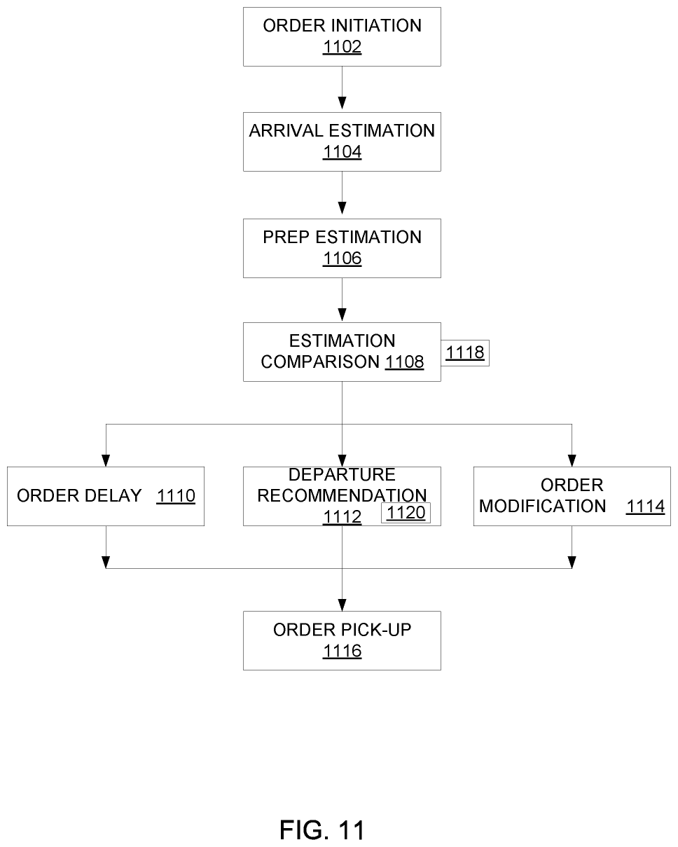

Referring now to FIG. 11, therein is show a control flow for the navigation system 100. In this example, the control flow can represent the sequence flow from FIG. 5 to FIG. 10. As an example, the navigation system 100 include an order initiation module 1102, an arrival estimation module 1104, a preparation estimation module 1106, an estimation comparison module 1108, an order delay module 1110, a departure recommendation module 1112, an order modification module 1114, an order pick-up module 1116, or a combination thereof.

The aforementioned modules can be included in the first software 220 of FIG. 2, the second software 244 of FIG. 2, or a combination thereof. The first software 220, the second software 244, or a combination thereof can be executed with the first control unit 210 of FIG. 2, the second control unit 238 of FIG. 2, or a combination thereof. The modules can be executed by the navigation system 100, the first device 102 of FIG. 1, the second device 106 of FIG. 1, or a combination thereof.

The example shown in FIG. 11, the aforementioned modules are coupled to one another as depicted in FIG. 11. The modules can be coupled using wired or wireless connections, by including an output of one module as an input of the other module, by including operations of one module influence operation of the other module, or a combination thereof. The modules can be directly coupled with no intervening structures or objects other than the connector there-between, or indirectly coupled.

The order initiation module 1102 is when the order 302 of FIG. 3 is entered or received by the navigation system 100. The order 302 be inputted into the order initiation module 1102 can number of ways. Examples of the order 302 input are described in described earlier.

The order initiation module 1102 can also receive the merchant or the vendor for the order 302. The order initiation module 1102 can determine the destination 424 based on the initiation of the order 302. The destination 424 is the geographic location for the merchant or the vendor associated with the order 302. The flow can progress to the arrival estimation module 1104.

The arrival estimation module 1104 generates a travel time 1118 for the navigation route 420 of FIG. 3 to the destination 424. The arrival estimation module 1104 can generate the navigation route 420. The navigation route 420 can vary depending on a number of factors. The factors for generating the navigation route 420 can be similar to the factors for determining the travel time 1118.

In this example, the travel time 1118 is the amount of time needed to traverse the navigation route 420. The travel time 1118 can vary depending on a number of factors. For example, the travel time 1118 can be based on the time when the start of the traversal of the navigation route 420, traffic conditions at the start, weather conditions, travel modalities, multi-modal travel schedules, or a combination thereof.

Continuing with the description for the arrival estimation module 1104, the estimated arrival time 422 can be generated based on the time for start of the traversal of the navigation route 420 plus the travel time 1118. The estimated arrival time 422 can vary based on factors similar to the factors for the travel time 1118. The flow can progress to the preparation estimation module 1106.

The preparation estimation module 1106 determine or calculate the preparation time 504 of FIG. 5 for the order 302 for the merchant or the vendor at the destination 424. The preparation estimation module 1106 can calculate or determine the preparation time 504 in a number of ways. For example, the navigation system 100 can utilize historical data for the vendor or the merchant at the destination for the order 302. Other factors can be utilized such as the time of the initiation of the order 302 and how busy the merchant or the vendor at the destination is. Also for example, information for industry or local business similar to the merchant or the vendor at the destination 424 and the respective data for the preparation time 504 can provide an average value, a median value, or other data to improve the accuracy of the preparation time 504 for the item for the order 302.

Continuing the example for the preparation estimation module 1106, machine learning and artificial intelligence can be utilize to calculate the travel time 1118, the estimated arrival time 422, or a combination thereof. Further for example, the travel time 1118, the estimated arrival time 422, or combination thereof can be calculated or determined based on the description earlier. The travel time, the estimated arrival time 422, or a combination thereof can also be determined using unsupervised learning. The preparation estimation module 1106 can improve the accuracy of the preparation time 504 based on reinforcement learning as the navigation system 100 continues to operate. The flow can progress to the estimation comparison module 1108.

The estimation comparison module 1108 compares the preparation time 504 and the estimated arrival time 422. The estimation comparison module 1108 can also utilize the travel time 1118 to determine next steps. For example, when the travel time 1118, the estimated arrival time 422, or a combination thereof is greater than the preparation time 504, the flow can progress to the order delay module 1110. Also for example, when the travel time 1118 is less than the preparation time 504, the flow can progress to the departure recommendation module 1112. Further for example, flow can progress to the order modification module 1114.

The flow can progress to the order modification module 1114 based on a number of factors. For example, if neither the order delay module 1110 nor the departure recommendation module 1112 would not provide the order 302, then the flow can progress to the order modification module 1114. Also for example, the changes to the travel time 1118 during the traversal of the navigation route 420 or the availability of the order 302 at the destination 424 can also progress the flow to the order modification module 1114. Further for example, the navigation system 100 can also select the waypoint 428 along the navigation route 420 to fulfill the order 302, the flow can progress to the order modification module 1114.

The order delay module 1110 determines the ordering time 506 of FIG. 5 for the order 302. The order delay module 1110 can determine the ordering time 506 in a number of ways. For example, the order delay module 1110 can determine the delay time 604 of FIG. 6 to place the order 302 such that the estimated arrival time 422 is approximately at the end of the preparation time 504 for the order 302 at the destination 424. The flow can progress to the order pick-up module 1116.

The departure recommendation module 1112 determines the recommended departure time 430 of FIG. 4 to start the traversal of the navigation route 420 to the destination 424 for the order 302. The departure recommendation module 1112 can determine the recommended departure time 430 in a number of ways. For example, the departure recommendation module 1112 can determine a start delay 1120 by calculating the difference between the preparation time 504 and the travel time 1118. The start delay 1120 is the amount of time to delay a start of the traversal of the navigation route 420 from the time of initiation of the order 302. Also for example, the start delay 1120 can also be adjusted based on changing conditions along the navigation route 420 or a change of the navigation route 420 based on similar factors to the travel time 1118 described earlier. The flow can progress to the order pick-up module 1116.

The order modification module 1114 changes the order 302 from the one initiated. The order modification module 1114 can change the order 302 in a number of ways. For example, the order modification module 1114 can modify the navigation route 420 when the waypoint 428 can fulfill the order 302 before traversal of the navigation route 420 to the destination 424. As an example, the waypoint 428 can be selected based on minimizing a detour for the navigation route 420 to fulfill the item for the order 302. Continuing with this example, the waypoint 428 can be selected based on the availability of the item for the order 302.

Also for example, the order modification module 1114 can change the navigation route 420 to another instance of the destination 424 to a different merchant or a different vendor when the traversal of the navigation route 420 takes a detour away from the initial instance of the destination 424 when the order 302 was initiated. Further for example, the order modification module 1114 can adjust or change the navigation route 420 for a different instance of the waypoint 428, the destination 424, or a combination thereof to fulfill the order 302 based on a number of factors, Examples of the factors can include nearest to a current location when the order 302 is initiated or at the time where the order 302 is potentially modified, minimizing the difference between the preparation time 504 and the estimated arrival time 522. The flow can progress to the order pick-up module 1116.

The order pick-up module 1116 fulfills the order 302. The order pick-up module 1116 can fulfill the order 302 in a number of ways. For example, item for the order 302 can be fulfilled at the waypoint 428 of the navigation route 420 and not the destination 424 initially designated in the order 302. Also for example, the item for the order 302 can be fulfilled at a different instance of the destination 424 for a different merchant or a different vendor.

For illustrative purposes, the control flow is shown and described in the order in FIG. 11, although it is understood that the navigation system 100 can implement the control flow differently. For example, the sequence of the arrival estimation module 1104 and the preparation estimation module 1106 can be reversed. Also for example, the order modification module 1114 can progress to the arrival estimation module 1104, to the preparation estimation module 1106, or a combination thereof.

It has been discovered that the navigation system 100 increases efficiency for ordering items through an automated processes that allows a user and vendors or merchants to optimize a schedule for picking up or delivering items such that the item can be picked up or delivered closer to the preparation time 504.

It has been further discovered that the navigation system 100 provides for significant time saving to both users and merchants or vendors when preparing itself for pickup or delivery because it brings greater transparency to the ordering process and allows both merchants and vendors and the user to know the status of each other and of the item being prepared. The examples used to describe embodiments are food but are easily application to medical needs, such as medication or service for medical aide.

The modules of the navigation system 100 can partitioned differently or order the modules differently. For example, the first software 220 of FIG. 2 of the first device 102 can include the modules for the navigation system 100. The first control unit 210 of FIG. 2 can execute the first software 220 to operate the modules.

In another example of module partitions, the second software 244 of FIG. 2 of the second device 106 can include the modules for the navigation system 100. The second control unit 238 of FIG. 2 can execute the second software 244 to operate the modules.

The first software 220 or the second software 244 can be a standalone application software, cloud based software, or integrated software between one or more software programs. Moreover, in one embodiment, the first software 220, the second software 244, or a combination thereof can integrate to a third party software to provide the functionality of the order optimization mechanism of the navigation system 100. For example, in one embodiment, the first software 220, the second software 244, or a combination thereof can integrate into a merchant or vendor's own restaurant management platform to provide the functionality of the order optimization mechanism. In another embodiment, the first software 220 or the second software 244 can be the merchant or vendor's restaurant management platform and work in conjunction with the second software 244 or the first software 220 to provide the functionality of the order optimization mechanism.

The modules described in this application can be implemented as instructions stored on a non-transitory computer readable medium to be executed by the first control unit 210, the second control unit 238, or a combination thereof. The non-transitory computer readable medium can include the first storage unit 216, the second storage unit 240, or a combination thereof. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the navigation system 100 or installed as a removable portion of the navigation system 100.

The physical transformation of the navigation route 420, the estimated arrival time 422, the preparation time 504, the order 302, the ordering time 506 results in movement in the physical world, such as physical change in information or environment processed for the user on one or more of the devices or physical displacement of the first device 102, the second device 106, the item being ordered, or a combination thereof. Movement in the physical world results in updates to the navigation route 420, the order 302, the estimated arrival time 422, or a combination thereof, which can be fed back into the navigation system 100 and further influence operation or update the first device 102, the second device 106, the item being ordered, or a combination thereof.

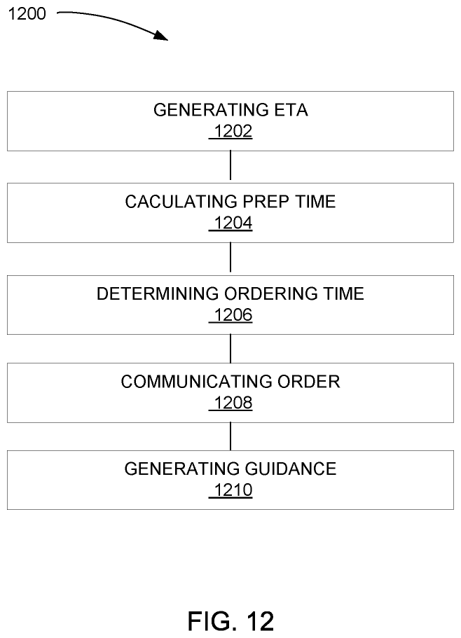

Referring now to FIG. 12, therein is shown a flow chart of a method 1200 of operation of a navigation system 100 in a further embodiment of the present invention. The method 1200 includes: generating an estimated arrival time for a navigation route including a destination in a box 1202; calculating a preparation time for an order in a box 1204; determining an ordering time to place the order to the destination such that the estimated arrival time at the destination is approximately at an end of the preparation time in a box 1206; communicating the order at the ordering time in a box 1208; and generating a guidance for the navigation route to arrive at the destination at approximately at an end of the preparation time in a box 1210.

The resulting method, process, apparatus, device, product, and system is cost-effective, highly versatile, and accurate, and can be implemented by adapting components for ready, efficient, and economical manufacturing, application, and utilization. Another important aspect of an embodiment of the present invention is that it valuably supports and services the historical trend of reducing costs, simplifying systems, and increasing performance.

These and other valuable aspects of the embodiments of the present invention consequently further the state of the technology to at least the next level. While the invention has been described in conjunction with a specific best mode, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A method of operation of a navigation system comprising:
generating an estimated arrival time for a navigation route including a destination;
calculating a preparation time for an order;
determining an ordering time to place the order to the destination such that the estimated arrival time at the destination is approximately at an end of the preparation time;
communicating the order at the ordering time; and
generating a guidance for the navigation route to arrive at the destination at approximately at an end of the preparation time.

2. The method as claimed in claim 1 wherein determining the ordering time includes determining a delay time to place the order.

3. The method as claimed in claim 1 wherein determining the ordering time includes determining a travel time of the navigation route greater than the preparation time.

4. The method as claimed in claim 1 wherein generating the guidance includes determining a recommended departure time.

5. The method as claimed in claim 1 further comprising:
modifying the order with a further destination; and
wherein:
generating the guidance includes modifying the guidance to the further destination.

6. The method as claimed in claim 1 wherein generating the guidance includes generating the guidance to a waypoint fulfilling the order.

7. The method as claimed in claim 1 wherein generating the guidance includes determining a start delay when a travel time of the navigation route is less than the preparation time.

8. A navigation system comprising:
a control unit configured to:
generate an estimated arrival time for a navigation route including a destination;
calculate a preparation time for an order;
determine an ordering time to place the order to the destination such that the estimated arrival time at the destination is approximately at an end of the preparation time;
generate a guidance for the navigation route to arrive at the destination at approximately at an end of the preparation time; and
a communication unit, coupled to the control unit, configured to communicate the order at the ordering time.

9. The system as claimed in claim 8 wherein the control unit is further configured to determine a delay time to place the order.

10. The system as claimed in claim 8 wherein the control unit is further configured to determine a travel time of the navigation route greater than the preparation time

11. The system as claimed in claim 8 wherein the control unit is further configured to determine a recommended departure time.

12. The system as claimed in claim 8 wherein the control unit is further configured to:
modify the order with a further destination; and
modify the guidance to the further destination.

13. The system as claimed in claim 8 wherein the control unit is further configured to generate the guidance to a waypoint fulfilling the order.

14. The system as claimed in claim 8 wherein the control unit is further configured to determine a start delay when a travel time of the navigation route is less than the preparation time.

15. A non-transitory computer readable medium including instructions executable by the control unit for a navigation system comprising:
generating an estimated arrival time for a navigation route including a destination;
calculating a preparation time for an order;
determining an ordering time to place the order to the destination such that the estimated arrival time at the destination is approximately at an end of the preparation time;
communicating the order at the ordering time; and
generating a guidance for the navigation route to arrive at the destination at approximately at an end of the preparation time.

16. The non-transitory computer readable medium as claimed in claim 15 wherein determining the ordering time includes determining a delay time to place the order.

17. The non-transitory computer readable medium as claimed in claim 15 wherein determining the ordering time includes determining a travel time of the navigation route greater than the preparation time.

18. The non-transitory computer readable medium as claimed in claim 15 wherein generating the guidance includes determining a recommended departure time.

19. The non-transitory computer readable medium as claimed in claim 15 further comprising:
modifying the order with a further destination; and
wherein:
generating the guidance includes modifying the guidance to the further destination.

20. The non-transitory computer readable medium as claimed in claim 15 wherein generating the guidance includes generating the guidance to a waypoint fulfilling the order.
